(19) United States
(12) Patent Application Publication
(10) Pub. No.: US 2009/0119452 A1
(43) Pub. Date: May 7, 2009

(54) METHOD AND SYSTEM FOR A SHARABLE STORAGE DEVICE

(75) Inventor: Brian J. Bianchi, Cedar Park, TX (US)

Correspondence Address: SPRINKLE IP LAW GROUP, 1301 W. 25TH STREET, SUITE 408, AUSTIN, TX, 78705, US

(73) Assignee: Crossroads Systems, Inc., Austin, TX (US)

(21) Appl. No.: 11/934,558

(22) Filed: Nov. 2, 2007

(51) Int. Cl. G06F 12/00; G06F 11/00

(52) U.S. Cl. 711/111; 711/154; 714/54; 711/E12.001; 714/E11.021

(57) ABSTRACT

Systems and methods for sharable tape devices are presented. More particularly, embodiments of a virtual tape server may automatically create a virtual tape device for an identified host such that hosts may interact with corresponding virtual tape devices. Thus, rather than having multiple hosts share a limited number of virtual tape devices, each host may interact with a virtual tape device corresponding only to that host (or a limited number of hosts), allowing substantially simultaneous interactions to take place between multiple hosts and multiple virtual tape devices and substantially alleviating the need of an application on a particular host to take into account other hosts or other applications when scheduling operations.

### TECHNICAL FIELD

The present invention relates to the field of data storage. More particularly, the present invention relates to storage libraries or devices. Even more particularly, the present invention relates to systems and methods for sharing storage devices.

### BACKGROUND

Data represents a significant asset for many entities. Consequently, data loss, whether accidental or caused by malicious activity, can be costly in terms of wasted manpower, loss of goodwill from customers, loss of time and potential legal liability. To ensure proper protection of data for business and legal purposes, many entities back up data to a physical storage media such as magnetic tapes or optical disks. Traditionally, backup would occur at each machine controlled by an entity. As the sophistication of network technology increased, many entities turned to enterprise level storage area networks (SAN) in which data from multiple machines on a network is backed up to a remote media library. Centralized data backup allows storage problems to be identified at one location and has the advantage of increased efficiency.

One example of a media library commonly used in enterprise backup systems is a magnetic tape library. In a typical magnetic tape library, tapes are contained in cartridges and the tape library contains multiple cartridge slots in which tape cartridges can be stored. The tape cartridges are physically moved between cartridge slots and tape drives by a robot. The robot is controlled by access commands received from the host devices on the network. When specific data is required, the host device determines which cartridge slot contains the tape cartridge that holds the desired data. The host device then transmits a move-element command to the robot and the robot moves the tape cartridge.

In a SCSI tape library, for example, devices that are part of the library are typically addressed by target number and logical unit numbers (“LUN”). Thus, each drive and robot of a tape library typically has a target number and LUN. Cartridge slots, on the other hand, are addressed by element numbers that are used by the robot to locate the slots. Because the robot also places tape cartridges in the drives, each drive is also associated with an element number. If multiple tape libraries are connected to a single device (e.g., a fibre channel to SCSI router), the tape libraries may be further addressed by bus number.

In current tape library systems, each tape library presents itself as an independent entity on the network. Each host in these systems maintains a view (i.e., a table of target numbers, LUNs and element numbers) of each of the tape libraries. Using this address information a host can format commands to the tape library to perform read/write, backup and other operations. In order to coordinate activities, hosts must cooperate with each other in issuing these commands. Enabling cooperation, however, requires reconfiguration of the hosts each time a new media library is added to the SAN. Moreover, to prevent conflicts between hosts, each host must typically use the same application to access a shared tape library. This can be inefficient as individual tape libraries cannot store data from multiple applications.

The operation of SANs such as those described above gives rise to potential problems. For instance, two or more hosts may attempt to access the same cartridge slot at the same time, but for data at different locations on the tape. In this situation, there is a conflict and the tape library system must somehow resolve the issue of which host's access request the system will respond to. The conflict becomes even more apparent when the tape library system has more than one tape drive. The system then has to resolve not only the question of which access request to respond to, but also which tape drive the tape should be loaded into.

These issues may be dealt with in software if the hosts use the same application or at least compatible applications. For example, if two hosts use the same backup application to store their data to tape, the application can coordinate the access requests of the two hosts so that both are backed up to the tape library. If, on the other hand, the two hosts use different backup applications, the applications will most likely not be able to coordinate their actions to ensure that both of the hosts are properly backed up, since they were probably independently designed and are consequently incompatible.

To remedy some of these issues, sometimes a storage area network will employ what is commonly referred to as a virtual tape library. In a virtual tape library a virtual tape server utilizes software to simulate a media library comprising one or more tape devices such that a host may access a virtual tape device as if it is accessing a physical tape device. Data written or otherwise accessed by a host may, however, be written to or read from a disk device by the virtual tape server. At some later point the data on the disk may or may not be written out to one or more actual physical tape or other type of devices. In this manner, the advantages of speed (e.g. both backup and restore speed) and the consolidation of storage offered by the use of disk may be gleaned without the need to update software on the hosts (such as backup processes or the like) which were designed to utilize physical tape devices.

No matter whether physical or virtual tape libraries are utilized in conjunction with a SAN, certain problems may arise. Specifically, many of these problems stem from the fact that only a limited number of physical tape devices (in the case of a physical media library) or a limited number of virtual tape devices (in the case of a virtual media library) may exist. Thus it may be the case that the limited number of physical or virtual tape devices must be shared among multiple hosts. Sharing of this type may be problematic, however.

More particularly, certain SAN applications such as Microsoft Software Initiator may not be ideally suited to sharing tape devices as these backup applications may operate as they are the only application accessing a particular tape device. Additionally, as tape devices are sequential access devices, it is difficult to coordinate access to the tape devices from the various hosts utilizing the tape devices. Coordination may be accomplished through the use of reserve and release commands (or the like), however, the use of these types of commands is still inefficient as hosts are still required to access a particular tape device sequentially.

### SUMMARY

Systems and methods for sharable tape devices are presented. More particularly, embodiments of a virtual tape server may automatically create a virtual tape device for an identified host such that hosts may interact with corresponding virtual tape devices. Thus, rather than having multiple hosts share a limited number of virtual tape devices, each host may interact with a virtual tape device corresponding only to that host (or a limited number of hosts), allowing substantially simultaneous interactions to take place between multiple hosts and multiple virtual tape devices and substantially alleviating the need of an application on a particular host to take into account other hosts or other applications when scheduling operations. Additionally, embodiments of the present invention may allow multiple virtual tape cartridges to be saved onto a single physical tape device, thereby better utilizing available physical tape media.

It will be noted that embodiments of the systems and methods presented herein can be implemented in standalone devices, routing devices such as routers, bridges, hubs or other routing devices or other types of network devices and that while embodiments have been illustrated utilizing virtual tape devices and a virtual tape server other embodiments may equally well apply to almost any other type of storage device (e.g. virtual disk server and virtual disk devices, etc.). Additionally, embodiments can be implemented has hardware and/or software programming. Embodiments can be implemented as computer instructions stored on any computer readable medium known in the art (e.g., optical disk, magnetic disk, flash memory, RAM, ROM, EEPROM or other computer readable medium).

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a diagrammatic representation of one embodiment of system comprising a virtual tape server.

FIG. 2A is a flow chart illustrating one embodiment of a method for implementing a virtual tape server.

FIG. 2B is a flow chart illustrating one embodiment of a method for implementing a virtual tape server.

FIG. 3 is a diagrammatic representation of one embodiment of system comprising a virtual tape server.

FIG. 4 is a diagrammatic representation of one embodiment of system comprising a virtual tape server.

FIG. 5 is a diagrammatic representation of one embodiment of system comprising a virtual tape server.

FIG. 6 is a diagrammatic representation of one embodiment of system comprising a virtual tape server.

### DETAILED DESCRIPTION

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. Skilled artisans should understand, however, that the detailed description and the specific examples, while disclosing preferred embodiments of the invention, are given by way of illustration only and not by way of limitation. Various substitutions, modifications, additions or rearrangements within the scope of the underlying inventive concept(s) will become apparent to those skilled in the art after reading this disclosure.

Reference is now made to the exemplary embodiments of the invention, examples of which are illustrated in the accompanying drawings. Wherever possible, the same reference numbers will be used throughout the drawings to refer to the same or like parts (elements).

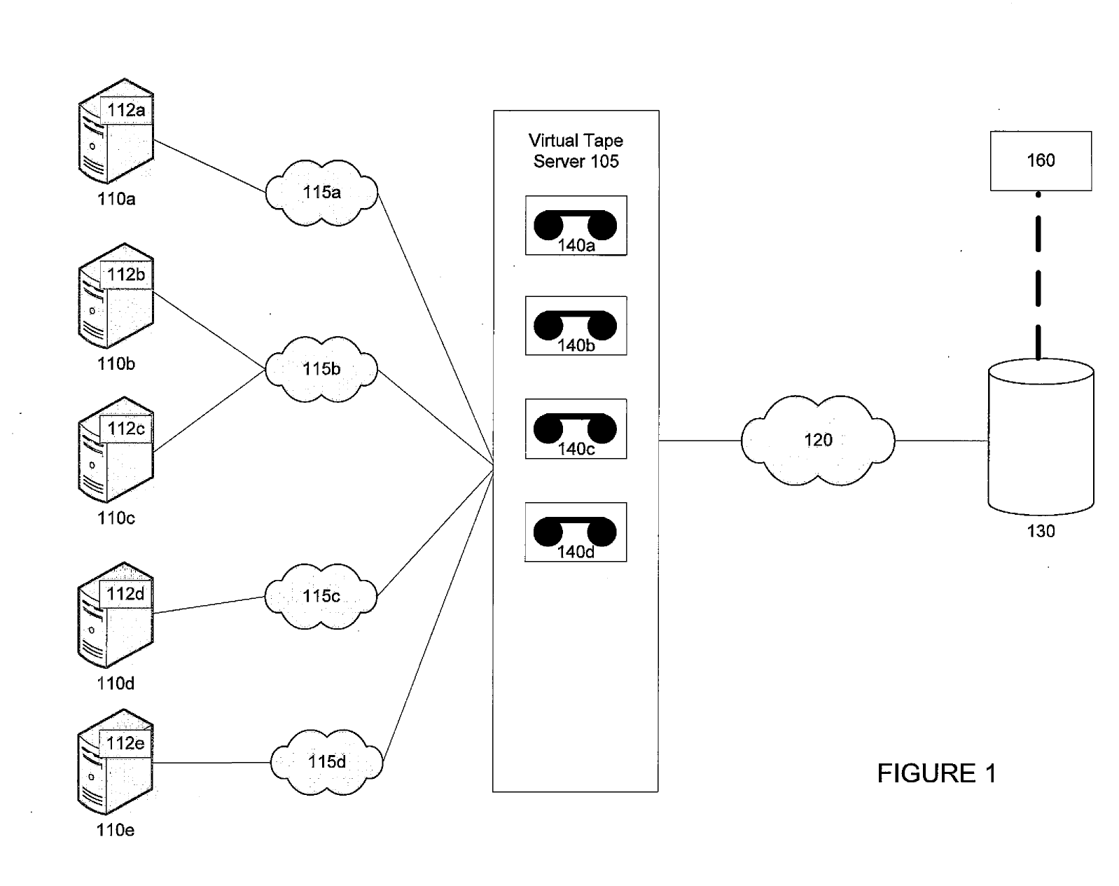

It may be helpful, before describing specific embodiments, to give a general description of a system in which a number of hosts have access to a virtual tape server through one or more various networks (i.e., data transport media). FIG. 1 is a diagrammatic representation of one embodiment of just such a system. In this embodiment, host 110a is connected to virtual tape server 105 via network 115a, hosts 110b and 110c are connected to virtual tape server 105 via network 115b, host 110d is connected to virtual tape server 105 via network 115c and host 110e is connected to virtual tape server 105 via network 115d. Each host can run one or more host applications (represented by host application 112a-e) configured to access a media library or storage devices, which may be for example applications designed to back-up the data stored on the respective host and scheduled to run at regular or semi-regular intervals. Network 115 can be a storage area network (“SAN”) operating according to any data communication protocol known in the art, including SCSI, iSCSI, Fibre Channel, serial attached SCSI (“SAS”), advanced technology attachment (“ATA”), serial ATA (“SATA”) or other protocol known in the art. In other embodiments, each network 115 can be the Internet, a LAN, a WAN, a wireless network or any other communications network known in the art.

Virtual tape server 105 may be coupled to storage media 110 and communicate with storage media 130 via data transport media 120 which may be the same as network 115 or which may utilize a different type of transport medium or protocol. Storage media 130 may be a disk device, a media changer with an associated medium transport element (alternatively referred to as a “robot” or “picker”), multiple storage elements that can store storage volumes (e.g., tape cartridges, optical disks) or storage media 130 may be another type of computer readable media altogether.

During operation, virtual tape server 105 may present one or more virtual tape devices 140 to host devices 110. These virtual tape devices 140 may each simulate a media library each having one or more tape drives and an associated media transport element (e.g. a “robot” or picker”) or another type of storage device (e.g. a single tape drive or any other type of storage media) such that host applications 112 may interact with virtual tape server 105 utilizing the same protocol or command set with which the application 112 would interact with a similar type of physical storage device. In other words, to application 112 it appears as if each of the virtual tape devices 140 are physical media libraries or devices and thus application 112 may format commands according to the configuration of the virtual tape devices 140 to perform read/write, backup and other operations as if it were interacting with an identically configured physical storage devices of the same type. When a command corresponding to a virtual tape device 140 is received by virtual tape server 105 it is placed in a buffer or queue for processing. Virtual tape server 105 may process these commands by translating the command from the protocol utilized by host 110 to a protocol suitable for accessing storage media 130.

The actual data corresponding to commands from applications 112 on hosts 110 is thus written to, read from, or otherwise accessed from storage media 130. The methodology used to store the data corresponding to the virtual tape devices 140 on storage media 130 may be almost any methodology imaginable which allows virtual tape server 105 to mimic the behavior of physical tape devices (e.g. media libraries or the like) which correspond to the virtual tape devices 140 and the format of files corresponding to tape. For example, a set of files may exist on storage media 130, where each of the files corresponds to a virtual cartridge of a virtual tape device 140.

These files on storage media 130 may, in one embodiment, be saved to an actual physical tape device 160 at some point to backup these files. The files on storage media 130 may, however, be stored sequentially (or in any other manner desired) on the tape cartridges of physical tape device 160. By storing various files corresponding to different virtual cartridges sequentially on the physical cartridges of physical tape device 160 better utilization of physical media may be obtained (relative to the utilization of physical media if the files corresponding to each virtual cartridge were themselves stored on separate physical cartridges)

As discussed above, however, virtual tape servers of this type are not without their problems. Some of these problems stem from the configuration of virtual tape server 105 In most cases, virtual taper server 105 is statically configured with respect to virtual tape devices 140, meaning that the number of virtual tape devices 140, etc. that virtual tape server 105 is configured to represent is constant during operation. Thus, no matter the number of hosts 110 accessing virtual tape server 105 the number of virtual tape devices 140 presented by virtual tape server 105 remains constant. As the number of virtual tape devices 140 remains constant, contention may occur between applications 112 on hosts 110 which wish to access virtual tape devices 140. This situation may be exacerbated by the behavior of certain applications 112 on hosts 110, for example certain backup applications may operate as if they are the only application accessing a particular virtual tape device and ignore data written to virtual cartridges of that virtual tape device by other applications. It is therefore desired to reduce contention for these virtual tape devices and therefore substantially reduce latency in accessing these virtual tape devices and thus allow host applications to schedule and perform operations (e.g. backup, etc.) on an individualized basis.

To that end attention is now directed to systems and methods for sharable tape devices. More particularly, embodiments of a virtual tape server may automatically create a virtual tape device for an identified host such that hosts may interact with corresponding virtual tape devices. Thus, rather than having multiple hosts share a limited number of virtual tape devices, each host may interact with a virtual tape device corresponding only to that host (or a limited number of hosts), allowing substantially simultaneous interactions to take place between multiple hosts and multiple virtual tape devices and substantially alleviating the need of an application on a particular host to take into account other hosts or other applications when scheduling operations.

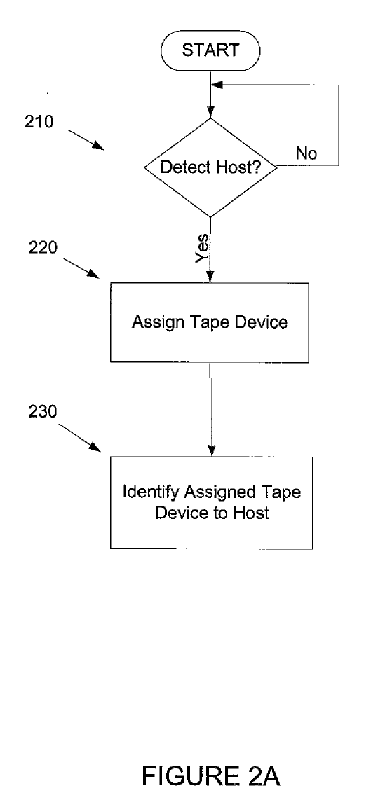

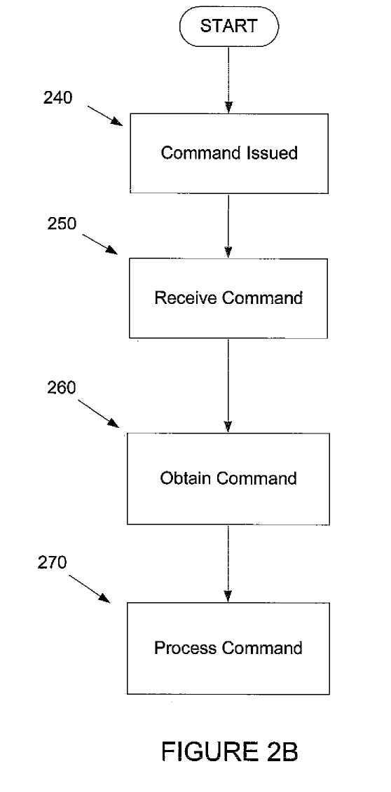

FIGS. 2A and 2B depict a flow diagram of one embodiment of a method for implementing just such a virtual tape server. At step 210 a host on a SAN (or other type of network) may be detected. During operation of a virtual tape server, when a host is identified or detected (step 210) a virtual tape device corresponding to the host may be created, or otherwise assigned, at step 220. These virtual tape devices, as discussed above, may each simulate a media library each having one or more tape drives and an associated media transport element (e.g. a “robot” or picker”) or another type of storage device (e.g. a single tape drive or any other type of storage media) such that host applications may interact with virtual tape server utilizing the same protocol or command set with which the application would interact with a similar type of physical storage device being emulated by the virtual tape device. The virtual tape device corresponding to the host may then be returned, or otherwise identified to, the host at step 230. Moving on to FIG. 2B, an application on a host may, at some point, issue a command to a corresponding virtual tape device (e.g. identified to the host at step 230) at step 240. This command may be in variety of formats or encapsulated according to a variety of data transport protocols. This command may be received and placed in a buffer at step 250, where there may be a general buffer where each received command is placed, there may be a buffer corresponding to each virtual tape device, or some other configuration of buffers may exist. The command may subsequently be obtained from the buffer at step 260 and processed at step 270. The processing may involve translating or otherwise forming a set of commands operable to interact with a storage media to effect the command sent from the host with respect to the storage media.

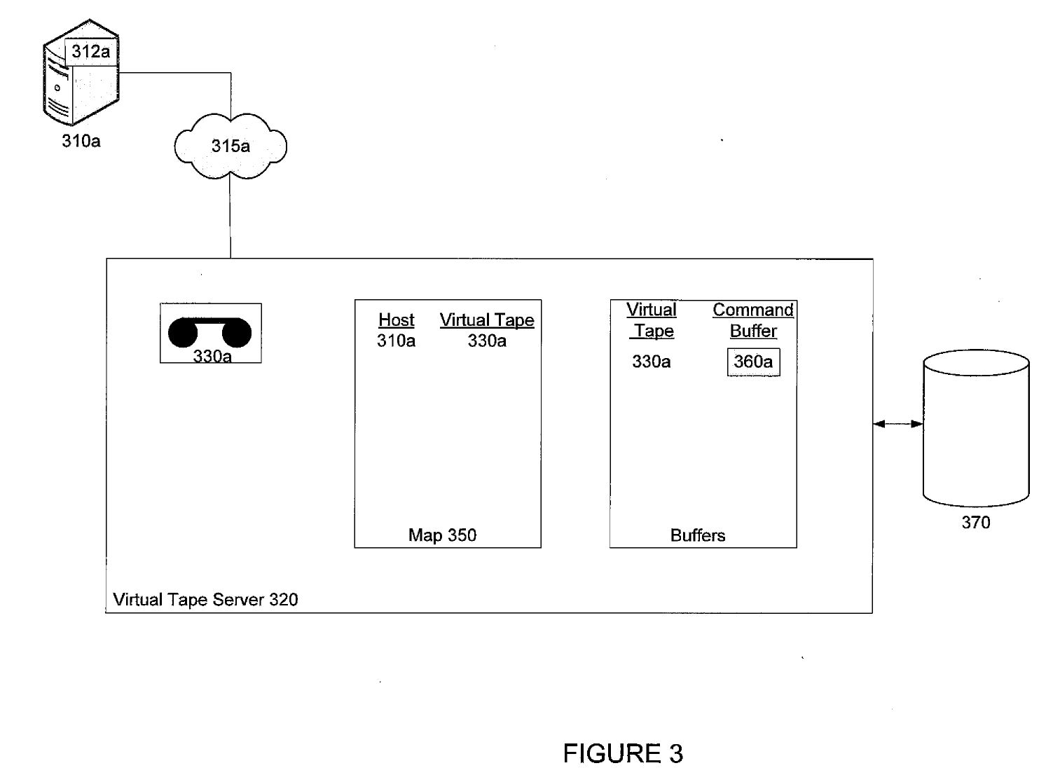

Embodiments of the method described above and embodiments of other methods for implementing a sharable tape device may be better understood with reference to FIG. 3-7, which depicts diagrammatic representations of embodiments of a system utilizing a virtual tape server. With reference first to FIG. 3, suppose that initially host 310a connects to virtual tape server 320 via network 315a where host 310a is an iSCSI device and network 315a is an iSCSI network. Host 310a will, when connected, send out a discovery command to locate accessible storage devices on network 315a or may try to login to virtual tape server 320. Virtual tape server 320 may receive this discovery command or login attempt and determine that a new host 310a has been identified or detected. Virtual tape server 320 may then create a virtual tape device 330a corresponding to that host 310a. In one embodiment a virtual tape device may simulate a media library each having one or more tape drives and an associated media transport element (e.g. a “robot” or picker”) with one or more associated tape library controller logical unit numbers (LUNs), or another type of storage device (e.g. a single tape drive or any other type of storage media) such that host applications may interact with a virtual tape server utilizing the same protocol or command set with which the application would interact with a similar type of physical storage device. The newly created virtual tape device 330a may then be associated with host 310a via a map 350, which may be, in one embodiment, a table (e.g. stored in memory used by virtual tape server 320) associating identifiers for a host 310 and a corresponding virtual tape device 330.

These identifiers may be, for example, the iSCSI identifier of the host 310, the IP address of the host 310, the DNS name of the host (which may be similar to an IP address, but would allow a machine to be tracked across IP address changes in a DHCP environment), a MAC address (which may be suitable in an environment such as IPv6, because the MAC address is a part of the IPv6 IP address), an IP subnet (e.g. different subnets may be associated with different types of host, for example where an engineering department has one subnet while the sales and marketing department has another), a world wide name (WWN), the name of the application 312 (e.g. iSCSI initiator software) on host 310 as the initiator's iSCSI name usually includes the iSCSI vendor, a target port on the virtual tape server 320 (e.g. hosts 310 that connect to one port get assigned one virtual tape device, hosts that connect to another port get a different virtual tape device, etc.), etc.

It will be apparent that the above examples of identifiers which may be utilized to associate a host 310 with a virtual tape device 330 is exemplary only and almost any method of mapping a host 310 to a virtual tape device 330 may be utilized, including those described in U.S. Pat. No. 6,041,381, entitled “Fibre Channel to SCSI Addressing Method and System,” issued Mar. 21, 2000 to Hoese, U.S. Pat. No. 5,941,972, entitled “Storage Router and Method for Providing Virtual Local Storage” by Hoese, et al., issued Aug. 24, 1999, U.S. Pat. No. 6,421,753, entitled “Storage Router and Method for Providing Virtual Local Storage” by Hoese, et al., issued Jul. 16, 2002, U.S. Pat. No. 6,425,035, entitled “Storage Router and Method for Providing Virtual Local Storage” by Hoese, et al., issued Jul. 23, 2002, U.S. Pat. No. 6,730,854, entitled “Storage Router and Method for Providing Virtual Local Storage” by Hoese, et al., issued May 18, 2004, U.S. Pat. No. 6,789,752, entitled “Storage Router and Method for Providing Virtual Local Storage” by Hoese, et al., issued Jul. 19, 2004, U.S. Pat. No. 6,763,419 entitled “Storage Router and Method for Providing Virtual Local Storage” by Hoese, et al., issued Sep. 7, 2004, U.S. patent application Ser. No. 10/658,163, filed Sep. 9, 2003, entitled “Storage Router and Method for Providing Virtual Local Storage” by Hoese, et al., each of which is hereby fully incorporated by reference herein.

After creating the virtual tape device 330a and mapping the host 310a to the created virtual tape device 330a, the virtual tape server 320 may return an identifier corresponding to the virtual tape device 330a to host 310a in response to the host's 310a initial inquiry command or login attempt.

Thereafter, to application 312a on host 310a it appears as if virtual tape device 330a is a physical tape device which may be utilized by application 312a and thus application 312a may format commands for virtual tape device 330a to perform read/write, backup or other operations as if it were interacting with a physical tape device configured identically to virtual tape device 330a. When a command corresponding to a virtual tape device 330a is received by virtual tape server 320 it is placed in a buffer 360a corresponding to that virtual tape device 330a for processing. Virtual tape server 320 may process these commands by translating the command from the protocol utilized by the host 310 which issued the command to a protocol suitable for accessing storage media 370. In particular, data may be stored and accessed in storage media 370 in one or more files corresponding to virtual tape device 330a in such a manner that a virtual tape server 320 can simulate a physical device substantially identical to virtual tape device 330a.

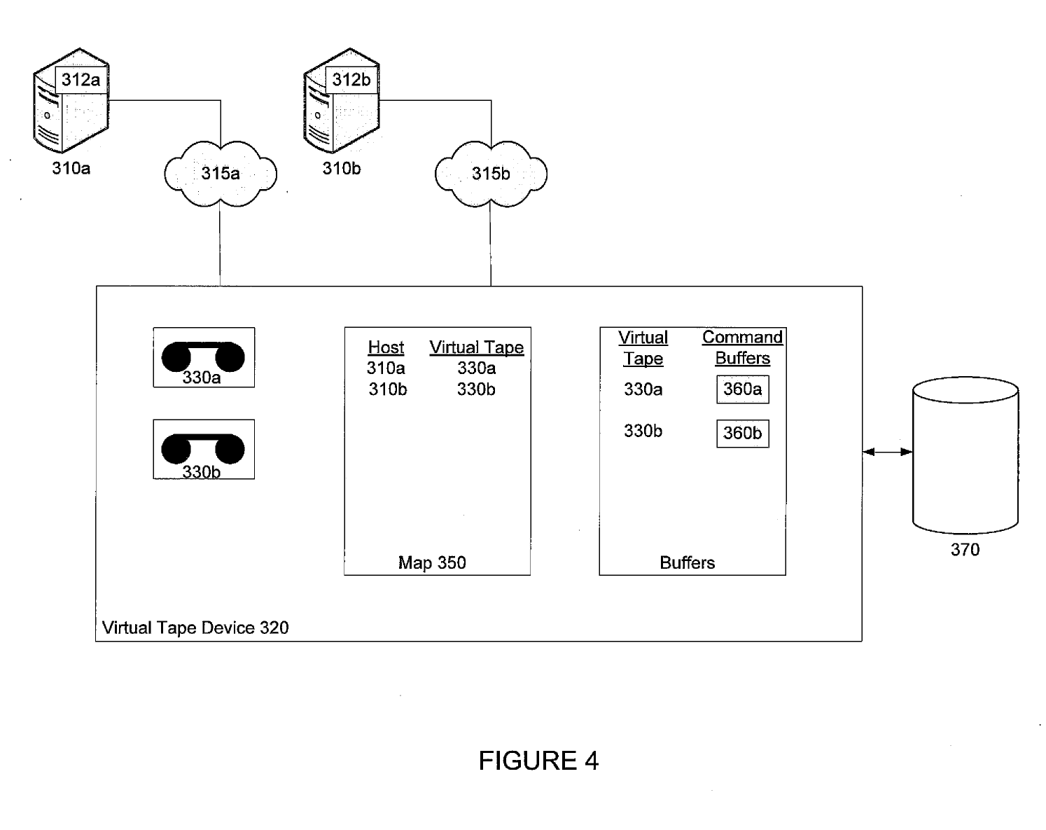

Moving now to FIG. 4, suppose now that host 310b connects to virtual tape server 320 via network 315b (which may be the same or different than network 315a). As discussed above, when host 310b is connected or booted it will attempt to locate storage devices. In response virtual tape server 320 may create a virtual tape device 330b corresponding to host 310b and associate the newly created virtual tape device 330b with host 310b via map 350. After creating the virtual tape device 330b and mapping the host 310b to the created virtual tape device 330b, the virtual tape server 320 may return an identifier corresponding to the virtual tape device 330b to host 310b in response to the host's 310b initial inquiry command or login attempt.

Thereafter, to application 312b on host 310b it appears as if virtual tape device 330b is a physical tape device which may be utilized by application 312b and thus application 312b may format commands for virtual tape device 330b to perform read/write, backup or other operations as if it were interacting with a physical tape device configured identically to virtual tape device 330b. When a command corresponding to a virtual tape device 330b is received by virtual tape server 320 it is placed in a buffer 360b corresponding to virtual tape device 330b for processing. Virtual tape server 320 may process these commands by translating the command from the protocol utilized by the issuing host 310 to a protocol suitable for accessing storage media 370.

Here, as can be seen, there may be multiple hosts 310 and multiple virtual tape devices 330 where each of these hosts 310 may be mapped to one or more distinct or different virtual tape devices 330. An application 312 on a host 310 may, however, still be provided with information about all virtual tape devices 330 on virtual tape server 320 (e.g. in response to an INQUIRY command, login attempt, other discovery technique, etc.) or otherwise be able to access or see” all virtual tape devices 330. In some cases, then an application on a host 310 may attempt to access a virtual tape device 330 other than the virtual tape device 330 to which the host 310 has been mapped. These types of accesses may cause problems, including causing the very contention which it is desired to avoid.

Consequently, in one embodiment, in addition to mapping hosts 310 to virtual tape devices 330, access controls are also implemented by virtual tape server 320 with respect to hosts 310 and virtual tape devices 330. In other words, one or more virtual tape devices 330 may be identified to a host 310 by virtual tape server 320 (e.g. in response to a SCSI INQUIRY command, login attempt, other discovery technique, etc. from the host 310). Whenever a command is received from a host 330, then, the virtual tape device 330 identified by the command (e.g. which the command is attempting to access) is checked against the virtual tape device(s) 330 mapped to the host 310 which issued the command. If the host 310 is mapped to the identified virtual tape device 330 the command is implemented by the virtual tape server 320 (e.g. placed in a buffer 360 corresponding to the identified virtual tape device 330), while if the host 310 which issued the command is not allowed to access the identified virtual tape device (e.g. the issuing host 310 is not mapped to, or is masked from, the identified virtual tape device 330) an error may be returned to the issuing host 310 or another action taken.

In one embodiment, to implement these access controls the host identifier in the command may be used to determine the virtual tape devices 330 which the issuing host 310 is allowed to access. Thus, it may be helpful to utilize an unmaskable or close to unmaskable host identifiers for hosts 310 (e.g. in conjunction with map 350). It will be noted that while almost any implementation of access controls may be utilized, in one embodiment access controls such as those described in the patent applications cited above may be utilized.

After reviewing the above description of certain embodiments it will be noted that the automatic creation of a virtual tape device 330 in response to the identification or detection of a new host 310 (e.g. in response to an INQUIRY command from a newly connected host, etc.) will substantially alleviate contention problems. In some cases however, it may not be desired to create a new virtual tape device 330 for each newly identified host 310. Consequently, in certain embodiments, a virtual tape device may be created based upon a ratio between the number of hosts 310 and the number of virtual tape devices 330, where the ratio ensures that an acceptable level of contention between hosts 310 and virtual tape devices 330 will be substantially maintained.

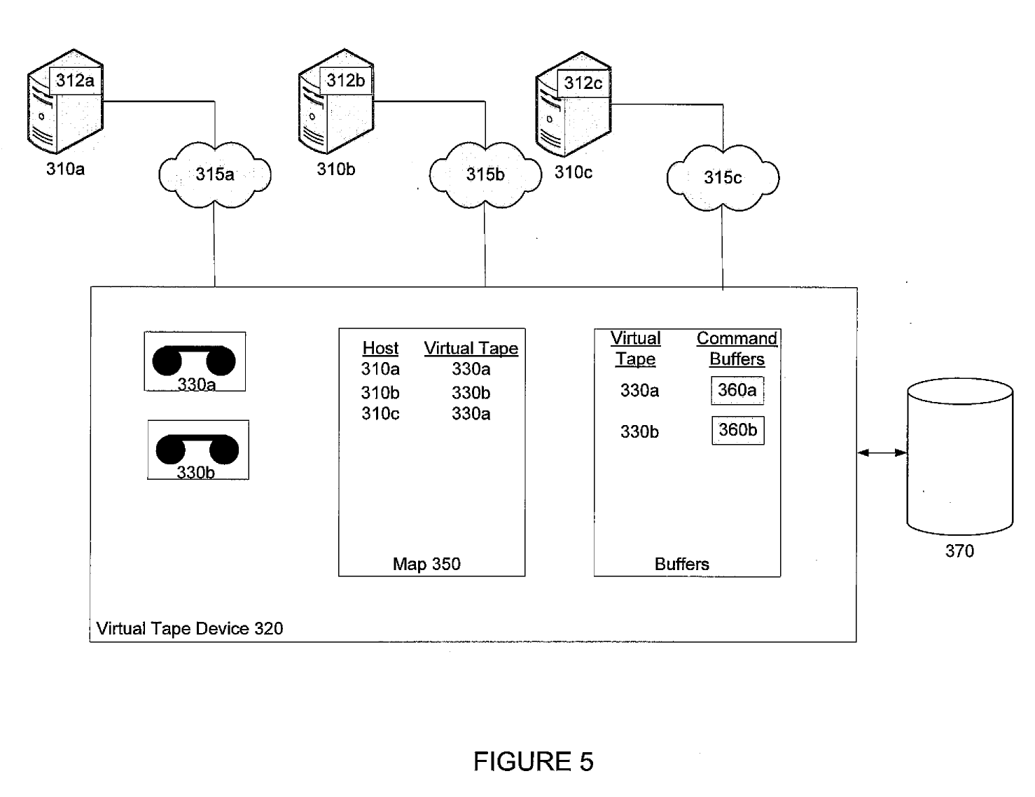

It may be helpful here to illustrate one example of an embodiment of a virtual tape server which creates virtual tape devices based upon a ratio between the number of hosts and the number of virtual tape devices. Turning to FIG. 5, one such embodiment where the ratio is two hosts for every virtual tape device is illustrated. For example, suppose initially that hosts 310a and 310b are mapped to virtual tape device 330a and 330b respectively. Now suppose that host 310c connects to virtual tape server 320 via network 315c (which may be the same or different than networks 315a or 315b). As discussed above, when host 310c is connected or booted it will attempt to locate storage devices. In response virtual tape server 320 may determine that a previously created virtual tape device 330a is only associated with one host 310 (e.g. using map 350) and may therefore associate previously created virtual tape device 330a with host 310c via map 350. In other words, in one embodiment, if a new host 310 is identified the virtual tape server 320 may determine if the desired ratio between virtual tape devices 330 and hosts 310 has been exceeded with respect to the previously created virtual tape devices 330. If the ratio has not been exceeded an existing virtual tape device 330 (e.g. where the number of hosts 310 currently assigned to that virtual tape device 330) may be associated with the new host 310. The virtual tape server 320 may then return an identifier corresponding to the virtual tape device 330a to host 310c in response to the host's 310c initial inquiry command or login attempt. Thereafter, to application 312c on host 310c it appears as if virtual tape device 330c is a physical tape device which may be utilized by application 312c and thus application 312c may format commands for virtual tape device 330a to perform read/write, backup or other operations as if it were interacting with a physical tape device configured identically to virtual tape device 330a. When a command corresponding to virtual tape device 330a (either from host 310a or host 310c) is received by virtual tape server 320 it is placed in a buffer 360a for processing.

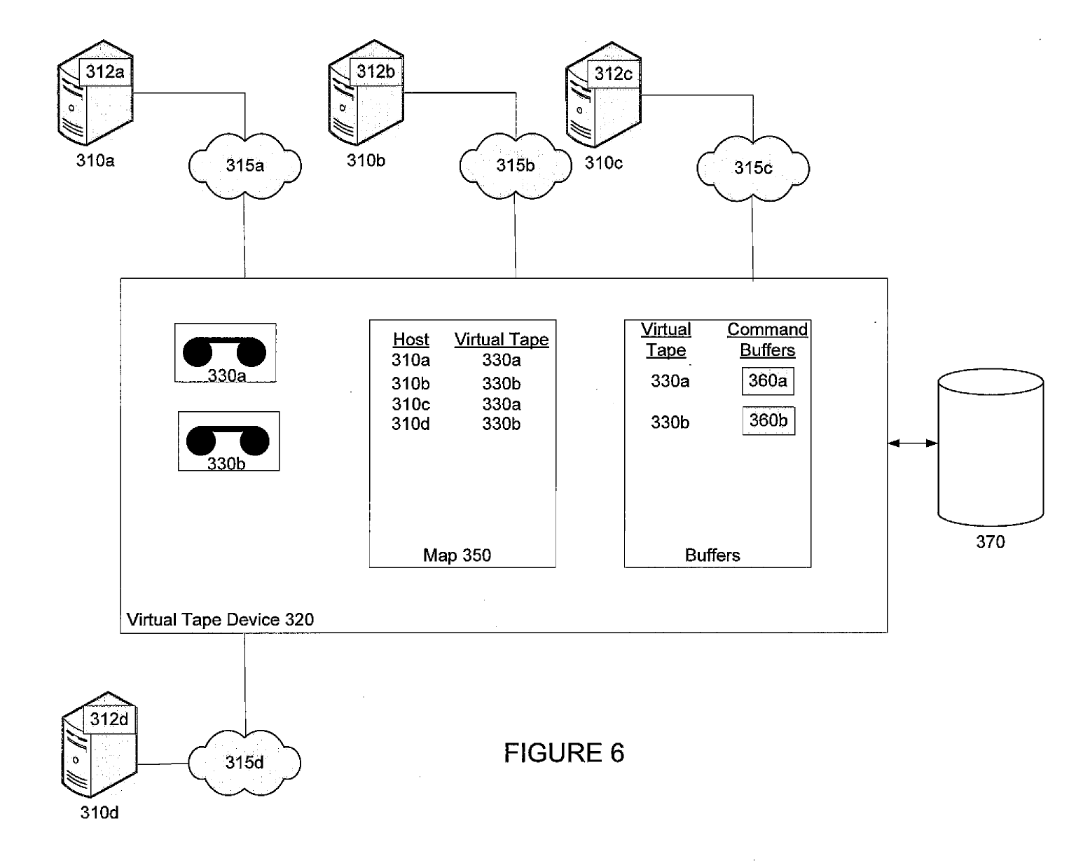

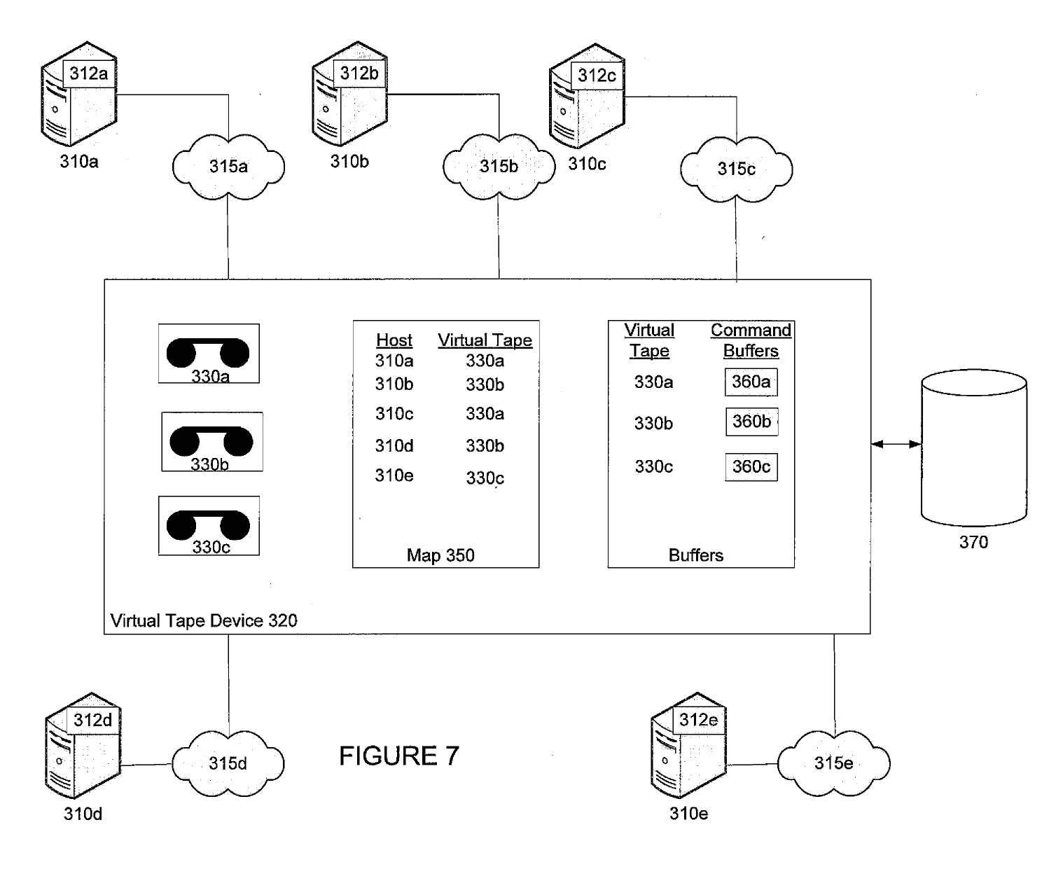

Similarly, with reference to FIG. 6, suppose now that host 310d connects to virtual tape server 320 via network 315d (which may be the same or different than networks 315a, 315b or 315c). Here, virtual tape server 320 may determine that a previously created virtual tape device 330a is associated with two hosts (310a and 310c) and virtual tape device 330b is only associated with one host 310b and may therefore associate previously created virtual tape device 330b with host 310d via map 350. The virtual tape server 320 may then return an identifier corresponding to the virtual tape device 330b to host 310d. Thereafter, to application 312d on host 310d it appears as if virtual tape device 330b is a physical tape device which may be utilized by application 312d and thus application 312d may format commands for virtual tape device 330b to perform read/write, backup or other operations as if it were interacting with a physical tape device configured identically to virtual tape device 330b. When a command corresponding to virtual tape device 330b (either from host 310b or host 310d) is received by virtual tape server 320 it is placed in a buffer 360b for processing.

Moving on to FIG. 7, suppose that at some point subsequently, host 310e connects to virtual tape server 320 via network 315e (which may be the same or different than networks 315a, 315b, 315c or 315d). Here, virtual tape server 320 may determine that previously created virtual tape device 330a is associated with two hosts (310a and 310c) and virtual tape device 330b is associated with two hosts (310b and 310d). Therefore, in this case virtual tape device 320 may create a virtual tape device 330c corresponding to host 310e and associate the newly created virtual tape device 330c with host 310e via map 350. In other words, here a new host 310 has been identified and the virtual tape server 320 has determined that the desired ratio between virtual tape devices 330 and hosts 310 has been exceeded.

After creating the virtual tape device 330c and mapping the host 310e to the created virtual tape device 330c, the virtual tape server 320 may return an identifier corresponding to the virtual tape device 330c to host 310e in response to the host's 310e initial inquiry command or login attempt. Thereafter, to application 312e on host 310e it appears as if virtual tape device 330c is a physical tape device which may be utilized by application 312e. When a command corresponding to virtual tape device 330c is received by virtual tape server 320 it is placed in a buffer 360c corresponding to that virtual tape device 330c for processing.

In this manner, as can be seen, a ratio of at least two hosts 310 for every virtual tape device 330 may be maintained by virtual tape server 320. By maintaining this ratio an acceptable level of contention between hosts 310 and virtual tape device 330 may be maintained. Of course it may be realized that rations other than a one to one or two to one ratio may be utilized in conjunction with various embodiments of virtual tape server 320 and that the particular ratio between hosts 310 and virtual tape devices 330 utilized in any particular embodiments may be dependent on a variety of factors including desired latency.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. For example, though embodiments have been described herein with respect to a virtual tape server and virtual tape device it will be understood generally that the same principles and descriptions will apply equally well to any other types of storage devices and that generally a virtual storage server will be able to provide instanced of virtual storage devices (e.g. a virtual disk server will provide virtual disk devices, etc.) in accordance with one or more embodiments of the systems and methods described herein.

Benefits, other advantages, and solutions to problems have been described above with regard to specific embodiments. However, the benefits, advantages, solutions to problems, and any components that may cause any benefit, advantage, or solution to occur or become more pronounced are not to be construed as a critical, required, or essential feature or component of any or all the claims.

What is claimed is:

1. A method for providing virtual storage, comprising:
detecting a first host;
creating a first virtual storage device based on the detection of the first host device; and
mapping the first virtual storage device to the first host wherein mapping the first virtual tape device to the first host comprises associating the first host with a first set of hosts corresponding to the first virtual storage device where only the first set of hosts corresponding to the first virtual storage device are allowed to access the first virtual storage device.

2. The method of claim 1, further comprising:
detecting a second host;
creating a second virtual storage device based on the detection of the second host device; and
mapping the second host to the second virtual storage device wherein mapping the second host to the second virtual storage device comprises associating the second host with a second set of hosts corresponding to the second virtual storage device wherein only the second set of hosts corresponding to the second virtual storage device are allowed to access the second virtual storage device.

3. The method of claim 1, further comprising:
detecting a second host;
determining if a ratio between a number of hosts and a number of virtual storage devices has been exceeded; and
if the ratio has not been exceeded mapping the second host to the first virtual storage device wherein mapping the second host to the first virtual storage device comprises associating the second host with the first set of hosts corresponding to the first virtual storage device wherein only the first set of hosts corresponding to the first virtual storage device are allowed to access the first virtual storage device.

4. The method of claim 3, wherein if the ratio has been equaled or exceeded:
creating a second virtual storage device; and
mapping the second host to the second virtual storage device wherein mapping the second host to the second virtual storage device comprises associating the second host with a second set of hosts corresponding to the second virtual storage device wherein only the second set of hosts corresponding to the second virtual storage device are allowed to access the second virtual storage device.

5. The method of claim 1, wherein the first host is an iSCSI, Fibre Channel (FC), SCSI or Serial Attached SCSI (SAS) device.

6. The method of claim 5, wherein detecting the first host comprises receiving a SCSI INQUIRY command from the first host.

7. The method of claim 6, further comprising:
receiving a command from the first host, wherein the command identifies a virtual storage device; and
determining if the identified virtual storage device is associated with the first host.

8. The method of claim 7, further comprising sending an error message if the identified virtual storage device is not associated with the first host.

9. The method of claim 8, further comprising placing the command in a buffer corresponding to the identified virtual storage device if the identified virtual storage device is associated with the first host.

10. The method of claim 9, wherein the first host is associated with the first set of hosts using an identifier for the first host.

11. A computer readable medium comprising a set of instructions, the instructions operable for:
detecting a first host;
creating a first virtual storage device based on the detection of the first host device; and
mapping the first virtual storage device to the first host wherein mapping the first virtual tape device to the first host comprises associating the first host with a first set of hosts corresponding to the first virtual storage device where only the first set of hosts corresponding to the first virtual storage device are allowed to access the first virtual storage device.

12. The computer readable medium of claim 11, the instructions further operable for:
detecting a second host;
creating a second virtual storage device based on the detection of the second host device; and
mapping the second host to the second virtual storage device wherein mapping the second host to the second virtual storage device comprises associating the second host with a second set of hosts corresponding to the second virtual storage device wherein only the second set of hosts corresponding to the second virtual storage device are allowed to access the second virtual storage device.

13. The computer readable medium of claim 11, the instructions further operable for:
detecting a second host;
determining if a ratio between a number of hosts and a number of virtual storage devices has been exceeded; and
if the ratio has not been exceeded mapping the second host to the first virtual storage device wherein mapping the second host to the first virtual storage device comprises associating the second host with the first set of hosts corresponding to the first virtual storage device wherein only the first set of hosts corresponding to the first virtual storage device are allowed to access the first virtual storage device.

14. The computer readable medium of claim 13, wherein if the ratio has been equaled or exceeded:
creating a second virtual storage device; and
mapping the second host to the second virtual storage device wherein mapping the second host to the second virtual storage device comprises associating the second host with a second set of hosts corresponding to the second virtual storage device wherein only the second set of hosts corresponding to the second virtual storage device are allowed to access the second virtual storage device.

15. The computer readable medium of claim 11, wherein the first host is an iSCSI, Fibre Channel (FC), SCSI or Serial Attached SCSI (SAS) device.

16. The computer readable medium of claim 15, wherein detecting the first host comprises receiving a SCSI INQUIRY command from the first host.

17. The computer readable medium of claim 16, the instructions further operable for:
receiving a command from the first host, wherein the command identifies a virtual storage device; and
determining if the identified virtual storage device is associated with the first host.

18. The computer readable medium of claim 17, the instructions further operable for sending an error message if the identified virtual storage device is not associated with the first host.

19. The computer readable medium of claim 18, the instructions further operable for placing the command in a buffer corresponding to the identified virtual storage device if the identified virtual storage device is associated with the first host.

20. The computer readable medium of claim 19, wherein the first host is associated with the first set of hosts using an identifier for the first host.
